(19) United States
(12) Patent Application Publication
(10) Pub. No.: US 2006/0290668 A1
(43) Pub. Date: Dec. 28, 2006

(54) Simplified user control and associated user interface

(75) Inventors: David Sloo, Menlo Park, CA (US); Ronald Alan Morris, San Francisco, CA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/165,928

(22) Filed: Jun. 23, 2005

(51) Int. Cl. G09G 5/08

(52) U.S. Cl. 345/158

(57) ABSTRACT

A user-input device includes a control having an axis. A circuit is coupled to the control and generates a first command signal in response to movement of the control about the axis from a first angular position to a second angular position. The circuit generates a second command signal in response to linear movement of the control from a first linear position to a second linear position. A transmitter may be coupled to the circuit to wirelessly transmit the first and second command signals to an electronic device.

### BACKGROUND

Users of modern digital-video-distribution systems, including cable, satellite, digital-terrestrial, and broadband, typically employ a traditional multi-button control unit (such as on a set-top box (STB) and/or remote-control device) that allows the user to navigate through operational choices. These remote controls typically have channel-adjust buttons, volume-adjust buttons, a “guide” button, a “menu” button, and additional buttons for maneuvering a cursor on the screen, selecting an option, and for “undoing” an option selection. Additionally, controls for systems that offer transport control of media or content recording include “trick-mode” buttons, such as “play,” “pause,” and the like, to invoke media-transport actions.

However, the versatility of these control units comes at a price. For example, because these units have multiple buttons, it is often difficult for a user to determine which button or sequence of buttons will, when pressed, achieve a desired objective. Additionally, because of the buttons are typically similar in shape, the user not only may be required to look at the unit to locate a desired button, but may also be required to procure sufficient light to do so.

### SUMMARY

This Summary is provided to generally introduce, in a simplified form, the reader to one or more select concepts described below in the Detailed Description. This Summary is not intended to identify key and/or required features of the claimed subject matter, nor is it intended to be used as an aid in determining the scope of the claimed subject matter.

An embodiment of the present invention provides a user-input device including a control having an axis. A circuit is coupled to the control and generates a first command signal in response to movement of the control about the axis from a first angular position to a second angular position. The circuit generates a second command signal in response to linear movement of the control from a first linear position to a second linear position. A transmitter is coupled to the circuit and wirelessly transmits the first and second command signals to an electronic device.

An embodiment of the present invention further provides a system including an electronic entertainment device controllable by a remote-control device having a manually operable controller. The system displays a first content set on a display device. In response to a user moving the controller in a first direction, the system transitions from display of the first content set to display of a second content set including at least one selectable option. In response to the user moving the controller in a second direction, the system transitions from display of the second content set to display of the first content set.

### BRIEF DESCRIPTION OF THE DRAWINGS

FIG. 1 is a schematic diagram of an illustrative interactive media system in which embodiments of the invention may be implemented;

FIG. 2 is a block diagram of components of a user-input device according to an embodiment of the invention;

FIGS. 3 to 5 are functional partial side views in partial cross section of the device of FIG. 2;

FIG. 6 is a screen display illustrating operational features according to an embodiment of the invention;

FIG. 7 is a screen display illustrating operational features according to an embodiment of the invention; and

FIG. 8 is a flow diagram of a method according to an embodiment of the invention.

### DETAILED DESCRIPTION

Generally described herein, among other things, is a simplified user-input device. This user-input device has a single controller that can be used to control functions of an interactive system such as an advanced television system. In an embodiment, the controller is a knob that can be turned in two angular directions, pushed and pulled. By turning the knob, a user can navigate through a range of selection choices such as, for example, volume settings or menu items. By pushing the knob, the user may select, for example, one or more of the navigable choices. By pulling the knob, the user may undo or cancel, for example, a previous selection.

Also described is a system implementable in an electronic entertainment device that enables control of entertainment-device functions using a single controller that may be part of a user-control device such as a remote-control device or a set-top-box control panel. In an embodiment, the system provides a user interface offering options that a user can navigate through, select and/or cancel selection of by manipulating only the controller. In this manner, the system provides full advanced-television-system functionality in response to a minimal number of control actions on the part of a user.

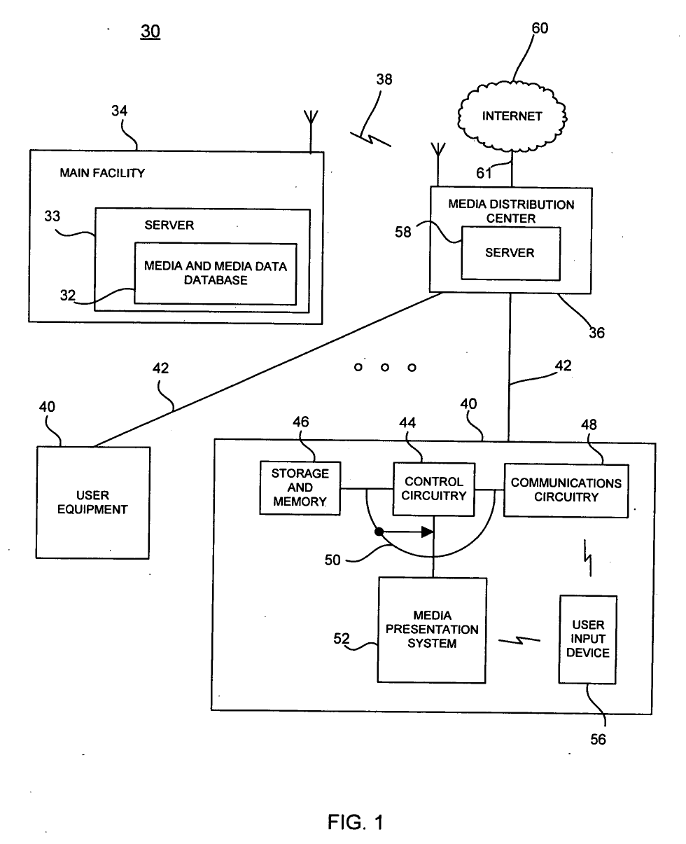

FIG. 1 illustrates an interactive media system 30 in which one or more embodiments of the invention may be implemented. The components of the interactive media system 30 described herein are exemplary and are not intended to suggest any limitation as to the scope of use or functionality of embodiments of the invention. The described embodiments of the invention should not be interpreted as having any particular dependency or requirement relating to any one component or combination of components illustrated in and described with reference to FIG. 1.

The interactive media system 30 may include a main facility 34, a media distribution facility 36, and user equipment 40, including one or more client devices. Although only one main facility 34 is illustrated in FIG. 1, the interactive media system 30 may include multiple main facilities. For clarity, embodiments of the invention will be at least primarily discussed in connection with the use of one such main facility. The main facility 34 may include a server 33 for storing and distributing media programs and associated media data from a media and media data database 32, which may be used for storing media programs and/or media data.

Media programs may include audio and/or video media such as broadcast television programs, cable television programs, pay-per-view programs, video-on-demand (VOD) programs, near video-on-demand (NVOD) programs, available-on-demand applications (e.g., on-demand interactive games), music, promotional material, radio, or any other type of deliverable media. The media programs may be associated with traditional broadcast channels (which are tuned by frequency), with IPTV broadcast channels (which are tuned by universal resource locator (URL)), and/or with any other types of channels over which media content may be transmitted. Media data may include data associated with the media programs, such as metadata, identifiers, URLs, interactive media application control information, program guide information (e.g., program guide listings data, pay-per-view ordering information, program promotional information, or any other suitable program guide information) or any other deliverable data.

Main facility 34 may distribute the media programs and media data to one or more media distribution facilities 36 via communications paths such as communications path 38. Communications path 38 may be any suitable communications path, such as a satellite link, a cable link, a fiber-optic link, a microwave link, a telephone network link, an Internet link, and/or a combination of such links. Although only one distribution facility 36 is illustrated in FIG. 1, the interactive media system 30 may include multiple distribution facilities. For clarity, the invention will be primarily discussed in connection with the use of one such distribution facility.

Media distribution facility 36 may be a broadcast television facility, a cable system headend, a satellite distribution facility, a broadcast music facility, and/or any other suitable media distribution facility for transmitting media programs and any other suitable information to user equipment 40. Media distribution facility 36 may include a server 58. Server 58 may be capable of handling media such as text, images, graphics, audio, video, any other suitable media, or a combination of such media. Server 58 may include a database for storing media programs, media data and/or any other suitable content. In addition, server 58 may be capable of providing interactive services such as NVOD and VOD. Server 58 may be based on one or more computers. Media distribution facility 36 may distribute various media programs to user equipment 40 over one or more communications paths 42, which may be unidirectional or bidirectional. Communication path 42 may be of the same as or different type as communication path 38.

Each media distribution facility 36 may have a number of associated users, each of which may have user equipment 40 coupled to the media distribution facility via one of communications paths 42. User equipment 40 may include equipment such as user television equipment, user computer equipment (e.g., a desktop computer, a laptop computer, a notebook computer, a handheld computing device such as a personal digital assistant or other small portable computer, STB, etc.), user music equipment (e.g., a stereo receiver) or any other suitable user media equipment for presenting media programs and/or executing an application, such as an interactive media application. An interactive media application may be implemented locally on user equipment 40 or may be implemented using a client-server or distributed architecture where some of the application is implemented locally on user equipment 40 in the form of a client process and some of the application is implemented at a remote location (e.g., media distribution facility 36) as a server process. Although one user equipment 40 is illustrated in FIG. 1, it is to be appreciated that any number of user equipments may be in communication with the one or more media distribution facility 36.

User equipment 40 may include electronic devices, such as control circuitry 44, storage and memory 46, communication circuitry 48, media presentation system 52, and/or user input device 56, for presenting media programs and/or implementing an interactive media application. The control circuitry 44, storage and memory 46, and communication circuitry 48 may be combined to form a conventional client device, such as, for example, a set-top box. The components may be configured to support functions of the interactive media application such as receiving media programs and media data, recording media programs to storage and memory 46, simultaneously recording and playing media programs, playing recorded media programs from storage, and sending and receiving application data and information. Control circuitry 44 may communicate with and/or control storage and memory 46, communications circuitry 48, and media presentation system 52 using communications paths 50. Paths 50 may be hard-wired, wireless (e.g., Bluetooth), optical paths or the like.

Storage and memory 46 may include a magnetic media recorder (e.g., hard disk drive or the like), memory (e.g. flash memory, EEPROM, or the like), a videocassette recorder, a digital recording device, any other suitable storage and memory device, or any suitable combination thereof. Some or all of storage and memory 46 may be located external to a device that contains control circuitry 44.

Control circuitry 44 may provide media presentation system 52 with media program content stored in storage and memory 46. Control circuitry 44 may also provide media presentation system 52 with media program content that is received from communications circuitry 48. Media presentation system 52 may include a television, a computer system with monitor and speakers, a stereo system, any other suitable presentation device, or any combination thereof.

The user may interact with control circuitry 44 using input device 56. The input device 56 may include features conventionally associated with a remote control, a keyboard, a wireless keyboard, a display remote, a handheld computer, a mouse, a trackball, a touch pad, buttons on a user device 40, and/or any other suitable interactive interface. User input device 56 may transmit signals to communications circuitry 48 or media presentation system 52 via any suitable communications path, such as a hard-wired or wireless path.

The features of embodiments of the present invention may be described herein in the context of an interactive media application implemented in, for example, software and/or firmware on one or more components of the system 30. This is only illustrative. An interactive media application implemented on any suitable platform (user computer equipment, user music equipment, or any other suitable platform) may be used to provide described features, such as displaying on a screen associated with the presentation system 52 a user interface navigable via operation of the input device 56.

The interactive media application may display information on user equipment 40, for example, in the form of an overlay, an interactive overlay, a program guide screen, or in any other suitable display format. The interactive media application may display information to inform the user as to the status of the interactive media application or media program, or in response to user inputs (e.g., change channel, play, pause, fast-forward, rewind, stop, etc.). This displayed information may be displayed for a certain period of time and then time out or may be removed in response to a user input (e.g., by operating a control associated with user input device 56).

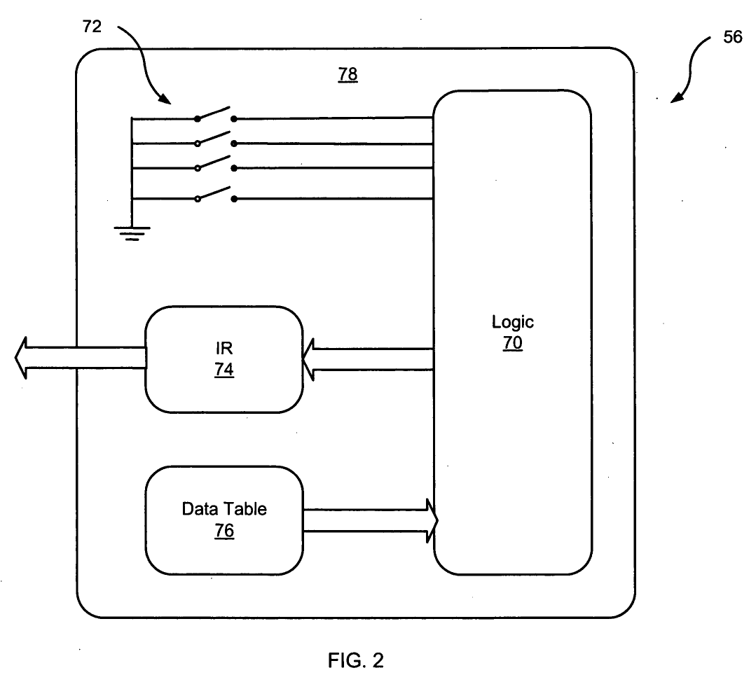

FIG. 2 shows basic components of an exemplary input device 56 in accordance with an embodiment of the invention. The input device 56 includes a decoding logic circuit 70 that is configured to receive and decode a plurality of switch inputs 72. Each switch corresponds to a key, button or other control (not shown) provided on a face (not shown) of the input device 56. The input device 56 may include a transmitter 74, such as an infrared or radio-frequency transmitter, for wirelessly transmitting to the control circuitry 44 signals generated by the logic 70 and corresponding to keystrokes, characters, and/or commands. A data or lookup table 76 is optionally associated with decoding logic 70 for reference when decoding sequences of switch inputs 72. In an embodiment, the logic 70 and data table 76 may be implemented as a microprocessor and associated electronic memory, respectively. In the illustrated embodiment, each of these input-device components is disposed within a housing 78.

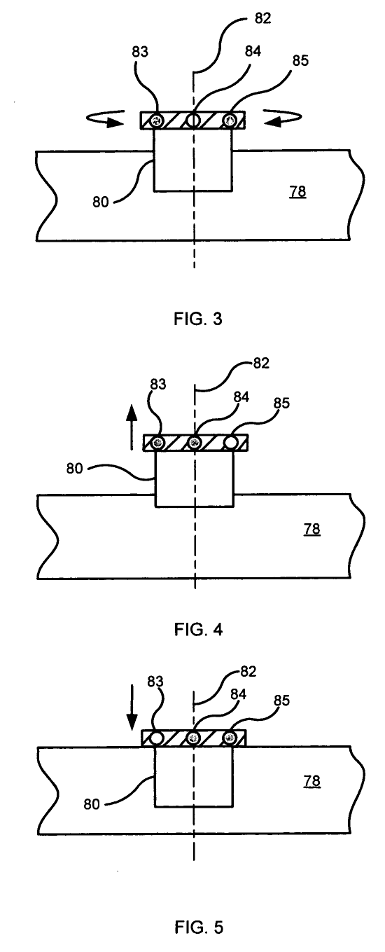

Referring to FIGS. 3-5, the input device 56, in an embodiment, further includes a manually operable control 80 coupled to and at least partially protruding from the housing 78. As shown in FIG. 3, the control 80 is configured as a knob coupled to the housing 78 in a manner that allows the control to be rotated about an axis 82 through a range of angular positions in both clockwise and counterclockwise directions. Alternatively, or additionally, the control 80 may be coupled to the housing 78 in a manner that allows the control to be moved along any axis (not shown) angularly separated from (such as perpendicular to) the axis 82. Additionally, and as shown in FIGS. 4 and 5 respectively, the control 80 is coupled to the housing 78 in a manner that allows the control to be moved translationally up and down (i.e., pulled and pushed) through a range of linear positions along the axis 82. For example, the control 80 may be moved from a first linear position depicted in FIG. 3 to second and third linear positions depicted in FIGS. 4 and 5, respectively. The control 80 may be coupled to or otherwise include a biasing element (not shown), such as a spring or resilient material, that causes the control to reside in the first linear position when not translationally moved by a user. The control 80 is further coupled to the switch inputs 72 (FIG. 2), such that movement of the control 80 results in a corresponding operational sequence of switch inputs 72 to decoding logic 70. Decoding logic 70, in conjunction with data table 76, decodes switch sequences and transmits corresponding command signals through the transmitter 74 to the control circuitry 44.

Each movement or, as discussed below in greater detail, combination of movements of the control 80 with respect to the axis 82 may be mapped to a particular command associated with conventional interaction between a user-input device and electronic devices such as those associated with the user equipment 40. For example, rotation of the control 80 about the axis 82 may enable the user to adjust the volume or channel setting of a television, or, in a user-interface context, rapidly scroll through a set of selectable options. A command signal may be generated by the input device 56 each time the control 80 is rotated through a predetermined angle, thereby enabling, as the control is rotated, rapid repetitive command input to other components of the user equipment 40. For example, such a command input may include a navigation signal that causes components of the user equipment 40 to display relative motion between a selection field and a sequence of selectable items. Pushing the control 80 along the axis 52 (i.e., moving the control toward the housing 78) may enable the user to select an indicated option, such as a channel, a television program, or a particular mode of interactive-television operation. Pulling the control 80 along the axis 82 (i.e., moving the control away from the housing 78) may generate an “undo” signal enabling the user to deselect a previously selected option. For example, after pushing the control 80 to transition from viewing a first program to viewing a second program, the user may pull the control to transition back to viewing the first program. Other examples of command input generated by pulling the control may include removing a displayed menu, restoring a previous menu, returning to a prior function mode, deselecting options, and the like.

In an embodiment, the control 80 may be simultaneously or sequentially moved along and rotated about the axis 82 to offer additional control possibilities. Each such combination of translational and rotational movement may be mapped to one of several corresponding control actions conventionally associated with control of advanced television systems. For example, the user may pull the control 80 and subsequently or simultaneously rotate the control in a clockwise (or counterclockwise) direction to increment (or decrement) a television-channel setting. Similarly, the user may push the control 80 and subsequently or simultaneously rotate the control in a counterclockwise (or clockwise) direction to decrement (or increment) a television-volume setting.

In an embodiment, the amount of time that the control 80 is held in a pulled or pushed state may correspond to respective different control actions. To this end, the input device 56 may include a conventional timing mechanism (not shown) operable to measure the duration for which the control 80 is pushed or pulled. Consequently, if the user pushes, for example, and holds the control 80 in a pushed position for a period of time greater than or equal to a predetermined duration (e.g., 0.25 seconds), the input device 56 may generate a first control signal. Otherwise, if the control 80 is pushed and held in the pushed position for a period of time less than the predetermined duration, the input device 56 may generate a second control signal different from the first control signal. Each such “press-and-hold” or “press-and-release” action by a user may be mapped to one of several corresponding control actions conventionally associated with control of advanced television systems. For example, a “press-and-hold” operation of the control 80 may effect a trick-mode operation, such as, for example, fast-forward, pause, rewind or skip. A “press-and-release” operation of the control 80 may cause, for example, a menu to be displayed. In an embodiment, the release of the “press and release” operation may be functionally implemented with the biasing element associated with the control 80. More particularly, a user may press the control 80 and the biasing element may return the control to the neutral position. Similarly, a pull and release may be facilitated by he biasing element.

In an embodiment, the control 80 is formed from a material, such as, for example, rubber or plastic, that is at least partially translucent. The control 80 may further include one or more illumination elements 83-85, such as, for example, light-emitting diodes, each of which may be coupled to a power supply (not shown), such as a battery. The elements 83-85 may each have a respective different illumination quality, such as, for example, color or intensity, to distinguish one element from the others. In an embodiment, one or more of the elements 83-85 illuminate in response to a respective corresponding movement of the control 80.

For example, as illustrated in FIG. 3, when the control 80 is rotated in a first (e.g., clockwise) direction about the axis 82, the illumination element 84 is activated (i.e., lit) to alert the user, as well as any other person able to see the control, that the control is being rotated in the first direction. Similarly, if the control 80 is rotated in a second (e.g., counterclockwise) direction about the axis 82, one or more illumination elements other than or additional to element 84 may be activated to alert the user that the control is being rotated in the second direction. As illustrated in FIG. 4, when the control 80 is pulled, the illumination element 85 is activated to alert the user that the control is being pulled. As illustrated in FIG. 5, when the control 80 is pushed, the illumination element 83 is activated to alert the user that the control is being pushed. If, for example, the control 80 is pushed and rotated clockwise, both elements 83 and 84 may illuminate to alert the user that the control is being pushed and rotated.

In an embodiment, each signal transmitted by the input device 56 as a result of operation of the control 80 in the described manner is operable to cause components of the user equipment to indicate the type of operation performed using the control. For example, a user interface (not shown) displayed via the presentation system 52 may be provided with a respective distinctive display quality similar to that of the illumination elements 83-85. Examples of a display quality may include any one or more of a cursor, color, brightness, contrast, hue, size, and the like. If the control 80 is pulled, for example, a user-interface element may be displayed in a first color to alert the user that the control is being pulled. If the control 80 is pushed, the user-interface element may be displayed in a second color to alert the user that the control is being pushed. Alternatively or additionally, an audible signal identifying the operation of the control 80 may be generated.

It should be noted that while the illumination elements 83-85 are displayed in FIGS. 3-5 as situated within the control 80 itself, the illumination elements may be alternatively situated in any portion of the housing 78 in a manner allowing a user of the input device 56 to perceive illumination of the elements. Additionally, more or fewer than the illustrated three elements 83-85 may be implemented in the input device 56 in a manner allowing a user to visually distinguish among movements of the control 80. In addition, an array of illumination elements, such as elements 83-85, may itself be regarded as an illumination element and may be activated in any combination and/or series to indicate an associated selected control, operation, and/or action.

Alternatively or additionally, a user in put device, other than a remote-control device, of the user equipment 40 may be physically coupled to (e.g., incorporate) the input device. For example, the control 80 may be directly mounted to an STB or other device including the control circuitry 44 and operate in the manner elsewhere described herein. In such an embodiment, the transmitter 74 and other components of the input device 56 may be omitted in favor of appropriate components, such as a hard-wired interface (not shown), allowing the input device to provide control signals to, or otherwise communicate with, the control circuitry 44.

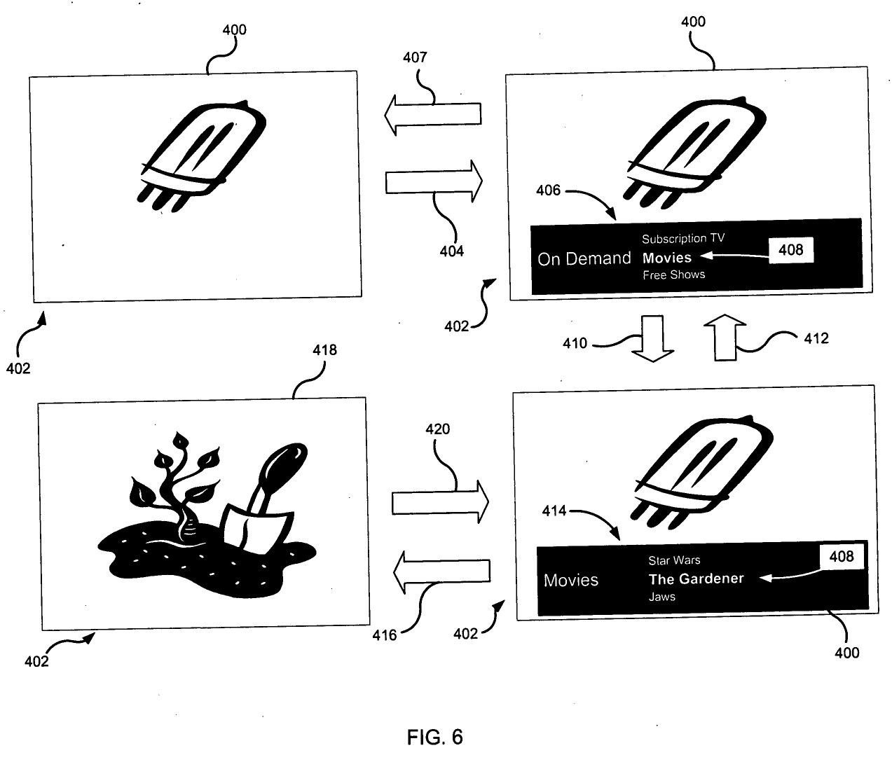

FIG. 6 depicts exemplary screen displays illustrating operation of an embodiment of the invention. Although operation of this embodiment is described with reference to the control 80, such reference is for purposes of example and not limitation; the embodiment may be implemented in conjunction with any suitable control associated with a remote-control and/or user-input device and operable to function in the described manner. In the illustrated embodiment, a user (not shown) of the system 30 is viewing a media program 400 on a screen 402 of the presentation system 52. During viewing of the media program, the user may decide to find and watch alternative programming or may wish to perform another operation related to the viewing experience. As indicated by the arrow 404, by operating the control 80 of the input device 56, the user can issue a signal encoding an instruction (i.e., an “invoke menu” instruction) that causes the system 30 to display a graphical user interface including a menu 406. For example, the instruction to invoke the menu 406 may be generated in response to the user pushing the control 80. The menu 406 may include any appropriate menu options, such as a menu associated with advanced television systems. Upon invoking the menu 406, the program 400 may or may not continue to be displayed on the screen 402. As indicated by the arrow 407, by operating the control 80, the user can issue a signal encoding an instruction that causes the system 30 to remove display of the menu 406. For example, the instruction to remove the menu 406 may be generated in response to the user pulling the control 80.

In the illustrated embodiment, the menu 406 includes a selection field 408. By operating the control 80, the user may generate one or more signals that enable the user to navigate the menu 406 by indicating successive menu options into the selection field 408. These navigation signals may be in response to the user rotating the control 80. For example, a navigation signal may be generated in response to the control 80 being rotated from a first angular position to a second angular position. For example, if the user rotates the control 80 in a clockwise direction, the input device 56 may generate a set of first navigation signals that causes options associated with the menu 406 to successively indicate in an upward direction with respect to the selection field 408. Similarly, if the user rotates the control 80 in a counterclockwise direction, the input device 56 may generate a set of second navigation signals that causes successive options associated with the menu 406 to be indicated in a downward direction with respect to the selection field 408. In an embodiment, the rate at which the menu options are highlighted is proportional to the rate at which the control 80 is rotated.

As indicated by the arrow 410, the user may operate the control 80 to generate a signal that selects an option indicated by the selection field 408. For example, this selection signal may be in response to the user pushing the control 80. In the illustrated example, selection of an option causes the menu 406 to be supplanted by a menu 414. It is to be appreciated that additional menus may replace, overlay, and the like the current menu display. As indicated by the arrow 412, by operating the control 80, the user can issue an instruction that effectively deselects the selected option and restores display of the menu 406. For example, the instruction to restore the menu 406 may be generated in response to the user pulling the control 80. In a further example, a second pull on the control 80 may remove the menu, as noted above.

In the illustrated embodiment, by selecting the indicated option (in the illustrated example, “On-Demand Movies”), the user invokes a second menu 414 that includes a navigable list of movies from which the user may choose. By operating the control 80, the user may navigate the menu 414 in a manner similar to that of navigating the menu 406. As indicated by the arrow 416, the user may operate the control 80 to generate a signal that selects an option indicated by the selection field 408. For example, this selection signal may be in response to the user pushing the control 80. In the illustrated example, selection of the option causes the system 30 to transition from display of the program 400 to display of a program 418 corresponding to the selected option. As indicated by the arrow 420, by operating the control 80, the user can issue an instruction that effectively deselects the selected option by causing the system 30 to transition from display of the program 418 back to display of the program 400. For example, the instruction to restore display of the program 400 may be generated in response to the user pulling the control 80.

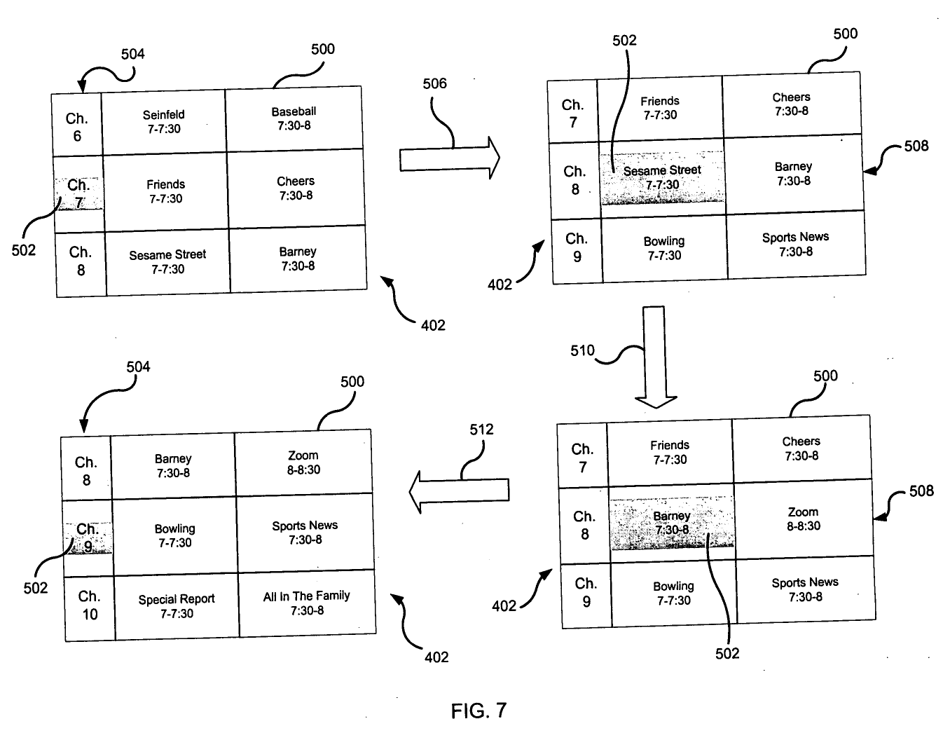

FIG. 7 depicts exemplary screen displays illustrating operation of an embodiment of the invention. Although operation of this embodiment is described with reference to the control 80, such reference is for purposes of example and not limitation; the embodiment may be implemented in conjunction with any suitable control associated with a user-control device such as a remote-control device or a set-top-box control panel and operable to function in the described manner. In the illustrated embodiment, a user of the system 30 is viewing an electronic program guide (EPG) 500 on a screen 402 of the presentation system 52. The EPG 500 is navigable using a selection field 502 (indicated in FIG. 7 by a gray cursor box) that, in the illustrated example, initially rests in a column 504 populated by a sequence of selectable broadcast-television-channel options. By operating the control 80, the user may generate one or more signals that enable the user to navigate the column 504 by indicating successive channel-selection options into the selection field 502. For example, these navigation signals may be in response to the user rotating the control 80.

As indicated by the arrow 506, the user may operate the control 80 to generate a signal that selects an option indicated by the selection field 502. For example, this selection signal may be in response to the user pushing the control 80. In the illustrated example, the user has selected for review a sequence of program selections associated with channel 8, and, consequently, the selection field 502 may be used to navigate the row 508 corresponding to channel 8. As indicated by the arrow 510, by operating the control 80, the user may navigate the row 508 by indicating successive program-selection options into the selection field 502. For example, these navigation signals may be in response to the user rotating the control 80. By operating the control 80, the user may select for viewing a program indicated by the selection field 502.

Alternatively, after reviewing the program-selection options associated with channel 8, the user may wish to review program-selection options associated with a different channel. As such, and as indicated by the arrow 512, the user may operate the control 80 to generate a signal that places the selection field 502 back into the channel-select column 504. For example, this signal may be generated in response to the user pulling the control 80. Subsequently, the user may operate the control 80 to continue scrolling through channel selections associated with the column 504.

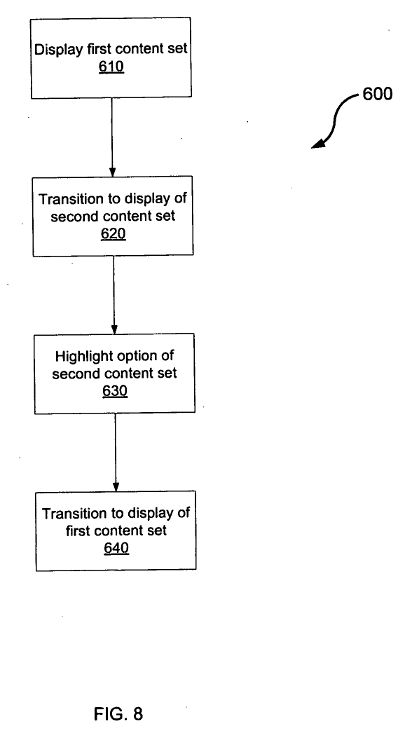

FIG. 8 illustrates a process 600 according to an embodiment of the invention. The process 600 is illustrated as a set of operations shown as discrete blocks. The process 600 may be implemented in any suitable hardware, software, firmware, or combination thereof. The order in which the operations are described is not to be necessarily construed as a limitation. Although this embodiment is described with reference to the control 80, such reference is for purposes of example and not limitation; the embodiment may be implemented in conjunction with any suitable control associated with a user-control device such as a remote-control device or a set-top-box control panel and operable to function in the described manner.

At a block 610, the system 30 displays on a display screen of the media presentation system 52 a first content set. For example, the first content set may include a broadcast or recorded television program, a graphical user interface, or a combination of program and user-interface elements. The system 30 may display the first content set in response to operation of a control, such as the control 80, associated with the input device 56.

At a block 620, the system 30 transitions from display of the first content set to display of a second content set. The system 30 transitions to display of the second content set in response to a user moving a controller, such as the control 80, in a first direction. For example, the user may rotate, push, pull or perform a combination of these actions with respect to the control 80 in order to display the second content set. The second content set includes at least one selectable option that may be indicated, for example, by a selection field such as a cursor or other display quality.

At a block 630, the system 30 displays relative motion between a selection field and selectable options of the second content set in order to indicate at least one such option. Such relative motion may include movement of the selection field relative to a static list of options or movement of the options relative to a static selection field. The system 30 performs this indicating function in response to a user moving the control 80 in an angular or linear direction. For example, the user may navigate (e.g., “scroll through”) the set of selectable options by rotating the control 80. The user may also select an indicated option by operating the control 80. For example, an option may be selected by pressing the control 80 from the first linear position to the second linear position.

At a block 640, the system 30 transitions from display of the second content set to display of the first content set. The system 30 transitions to display of the first content set in response to the user moving the control 80 in a second direction. For example, if the user previously invoked display of a menu by pressing the control 80, the user may cease display of the menu by pulling the control to a third linear position. If the user previously transitioned from display of a first menu to display of a selected option by, for example, pressing the control 80, the user may transition from the selected menu back to the first menu by, for example, pulling the control.

Embodiments within the scope of the present invention also include computer-readable media for carrying or having computer-executable instructions or data structures stored thereon. Such computer-readable media can be any available media that is accessible by a general-purpose or special-purpose computer or other electronic device. By way of example, and not limitation, such computer-readable media can include physical storage media such as RAM, ROM, EEPROM, CD-ROM or other optical disk storage, magnetic disk storage or other magnetic storage devices, or any other medium that can carry or store program code means. When information is encoded to be transferred or provided over a network or another communications connection (either hardwired, wireless, or a combination of hardwired or wireless) to an electronic device, the electronic device views the information encoded in the connection as a computer-readable medium. Thus, such a connection is also termed a computer-readable medium. Combinations of the above should also be included within the scope of computer-readable media.

The preceding discussion is presented to enable a person skilled in the art to make and use the invention. Various modifications to the disclosed embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein.

What is claimed is:

1. A user-input device, comprising:
a control having an axis;
a circuit coupled to the control, the circuit operable to generate a first command signal in response to movement of the control about the axis from a first angular position to a second angular position, the circuit further operable to generate a second command signal in response to linear movement of the control from a first linear position to a second linear position along the axis; and
a transmitter coupled to the circuit and operable to wirelessly transmit the first, second, and third command signals to an electronic device.

2. The device of claim 1 wherein the circuit is further operable to generate a third command signal in response to linear movement of the control along the axis from the first linear position to a third linear position, the third command signal being different from the second command signal.

3. The device of claim 2 wherein the axis is approximately perpendicular to a face of a housing of the user device.

4. The device of claim 3, further comprising a housing coupled to the control, wherein the linear movement is away from the housing.

5. The device of claim 1 wherein the circuit is further operable to generate a third command signal in response to simultaneous movement of the control to the second angular position and the second linear position, the third command signal being different from both the first command signal and the second command signal.

6. The device of claim 1 wherein:
the control is operable to move, in a period of time, from the first linear position to the second linear position and back to the first linear position;
if the time period is greater than or equal to a predetermined duration, the circuit is operable to generate the second command signal; and
if the time period is less than the duration, the circuit is operable to generate a third command signal, the third command signal being different from the second command signal.

7. The device of claim 1, further comprising at least one illumination element coupled to the circuit for indicating generation of at least one of the group comprising the first command signal and the second command signal.

8. The device of claim 7 wherein the illumination element exhibits a first illumination quality in response to movement of the control to the second angular position and exhibits a second illumination quality in response to movement of the control to the second linear position.

9. The device of claim 8 wherein the first illumination quality comprises illumination in a first color and the second illumination quality comprises illumination in a second color.

10. An interactive entertainment system, comprising:
control circuitry in communication with a display device screen; and
a user-input device having a manually operable controller, operation of the controller by a user producing a menu-invoke signal, a first navigation signal, a selection signal, and an undo signal, the user-input device operable to provide the signals to the control circuitry, wherein:
the menu-invoke signal being operable to cause the control circuitry to display on the display-device screen a first sequence of selectable items and an indicator operable to indicate an item of the first sequence;
the first navigation signal being operable to cause the control circuitry to display, in a first direction along the first sequence, relative motion between the indicator and the first-sequence items;
the selection signal being operable to select an indicated item; and
the undo signal being operable to undo the item selection.

11. The system of claim 10 wherein operation of the controller by the user producing an undo signal includes pulling the control away from a face of the user-input device.

12. The system of claim 10 wherein:
the control circuitry is further operable to display on the screen a second sequence of selectable items;
selection of the indicated item enabling the user to indicate a second item in the second-sequence of items; and
undoing the indicated item selection enabling the user to indicate an item in the first-sequence of items.

13. The system of claim 10 wherein:
the control circuitry is further operable to display on the screen a first content set;
selection of the indicated item causing the control circuitry to display on the screen a second content set; and
undoing the item selection causes the control circuitry to display on the screen the first content set.

14. The system of claim 13 wherein:
the first content set comprises the first sequence; and
the second content set comprises a second sequence of selectable items.

15. The system of claim 10 wherein operation of the controller by the user produces a second navigation signal, the second navigation signal operable to cause the control circuitry to display, in a second direction along the first sequence, relative motion between the field and the first-sequence items.

16. The system of claim 10 wherein the user-input device comprises a remote-control device.

17. A system comprising:
a) a set top box in communication with a display device, the display device for displaying a first content set;
b) a remote-control device for controlling the set top box and having a manually operable control having an axis, the control having a first linear position, a second linear position, and a third linear position aligned along the axis, the first linear position being between the second linear position and the third linear position, manipulation of the control from the first linear position to the second linear position along the axis generating a signal to the set top box to transition from display of the first content set to display of a second content set comprising at least one selectable option, and manipulation of the control from the first linear position to the third linear position generating a signal to the set top box to transition the display from the second content set to the first content set.

18. The system of claim 17 wherein the second content set comprises a sequence of selectable options, and manipulation of the control from a first angular position to a second angular position generating a signal to the set top box to transition an indicator to indicate a sequential option in the sequence of selectable options.

19. The system of claim 17 wherein the first content set comprises a sequence of selectable options.

20. The system of claim 17 wherein a second sequential manipulation of the control from the first linear position to the third linear position generating a signal to the set top box to transition the display from the first content set to a third content set displayed prior to the first content set.
